(19) United States
(12) Patent Application Publication
(10) Pub. No.: US 2022/0353480 A1
(43) Pub. Date: Nov. 3, 2022

(54) PROJECTION APPARATUS AND AUTOMATIC PROJECTION ADJUSTMENT METHOD

(71) Applicant: Coretronic Corporation, Hsin-Chu (TW)

(72) Inventors: Chien-Wei Wang, Hsin-Chu (TW); Po-Yen Wu, Hsinchu (TW); Chih-Lin Wang, Hsin-Chu (TW)

(73) Assignee: Coretronic Corporation, Hsin-Chu (TW)

(21) Appl. No.: 17/724,505

(22) Filed: Apr. 20, 2022

(30) Foreign Application Priority Data
Apr. 29, 2021 (CN) 202110474576.1

(51) Int. Cl. H04N 9/31

(52) U.S. Cl. CPC H04N 9/3194; H04N 9/3185

(57) ABSTRACT

A projection apparatus with an automatic adjustment function and an automatic projection adjustment method thereof are provided. The projection apparatus includes a control device, a projection device and a ranging device. The projection device is coupled to the control device. The ranging device is coupled to the control device. The control device operates the ranging device to perform multi-point ranging within a projection range of the projection device and on a projection surface. The control device determines whether a position of the projection range is suitable for projection according to a plurality of first distance values of a plurality of detection points provided by the ranging device, so as to adjust the projection range. The projection apparatus has an effect of accurate and automatic projection adjustment.

### CROSS-REFERENCE TO RELATED APPLICATION

This application claims the priority benefit of China application serial no. 202110474576.1, filed on Apr. 29, 2021. The entirety of the above-mentioned patent application is hereby incorporated by reference herein and made a part of this specification.

### BACKGROUND

### Technical Field

The invention relates to a display device, and particularly relates to projection apparatus with an automatic adjustment function and an automatic projection adjustment method thereof.

### Description of Related Art

During a projection process of conventional projection apparatus (a projector), if an area corresponding to a projection range on a projection surface is uneven or has an obstacle, a user may make the projection apparatus to project normally by only moving the projection apparatus or manually adjusting an lens of the projection apparatus. Moreover, even if the conventional projection apparatus may use a camera to capture the projection surface to determine whether the area corresponding to the projection range on the projection surface is uneven or has the obstacle, since the conventional projection apparatus determines the uneven area or a position of the obstacle in a manner of analyzing a two-dimensional image, when the uneven area or the obstacle has a step difference (a height difference) with a projection plane, the conventional projection apparatus cannot make effective judgment.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to projection apparatus with an automatic adjustment function and an automatic projection adjustment method thereof, which have a precise automatic projection adjustment effect.

Other objects and advantages of the invention may be further illustrated by the technical features broadly embodied and described as follows.

In order to achieve one or a portion of or all of the objects or other objects, an embodiment of the invention provides projection apparatus with an automatic adjustment function including a control device, a projection device and a ranging device. The projection device is coupled to the control device. The ranging device is coupled to the control device. The control device operates the ranging device to perform multi-point ranging within a projection range of the projection device and on a projection surface. The control device determines whether a position of the projection range is suitable for projection according to a plurality of first distance values of a plurality of detection points provided by the ranging device, so as to adjust the projection range.

In order to achieve one or a portion of or all of the objects or other objects, an embodiment of the invention provides an automatic projection adjustment method of projection apparatus including following steps. A ranging device performs multi-point ranging within a projection range of a projection device and on a projection surface; and it is determined whether a position of the projection range is suitable for projection according to a plurality of first distance values of a plurality of detection points provided by the ranging device, so as to adjust the projection range.

Based on the above description, the projection device with automatic adjustment function and the automatic projection adjustment method thereof of the invention may effectively detect whether the projection surface corresponding to the projection range is flat and used for projection by means of time-of-flight (ToF) ranging, so as to automatically adjust the projection range.

To make the aforementioned more comprehensible, several embodiments accompanied with drawings are described in detail as follows.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural diagram of projection apparatus according to an embodiment of the invention.

FIG. 2 is a flowchart of an automatic projection adjustment method according to an embodiment of the invention.

FIG. 3 is a schematic diagram of shifting a projection range according to an embodiment of the invention.

FIG. 4 is a schematic diagram of multi-point ranging according to an embodiment of the invention.

FIG. 5 is a schematic diagram of shifting a projection range according to another embodiment of the invention.

FIG. 6 is a schematic diagram of zooming in a projection range according to an embodiment of the invention.

FIG. 7 is a flowchart of an automatic projection adjustment method according to another embodiment of the invention.

### DESCRIPTION OF THE EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

The above and other technical contents, features, and effects of the invention will be clearly presented in the following detailed description of a preferred embodiment with reference to the accompanying drawings. Directional terminology, such as “top,” “bottom,” “left,” “right,” “front,” “back,” etc., mentioned in the following embodiments is used with reference to the orientation of the Figure(s) being described and are not intended to be limiting of the invention.

In order to make the content of the invention more comprehensible, the following embodiments are specifically cited as examples on which the invention may indeed be implemented. In addition, wherever possible, elements/components/steps with the same reference numbers in the drawings and embodiments represent the same or similar components.

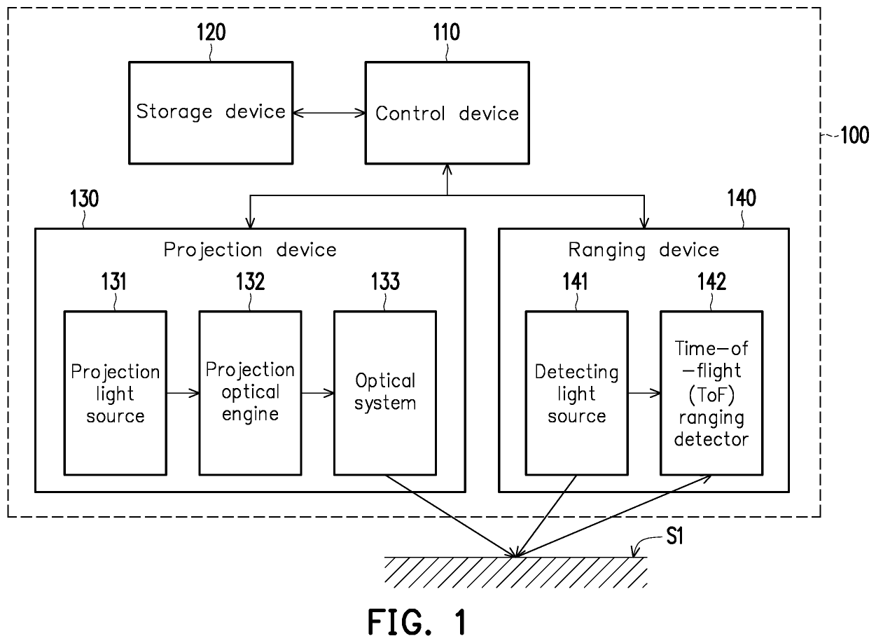

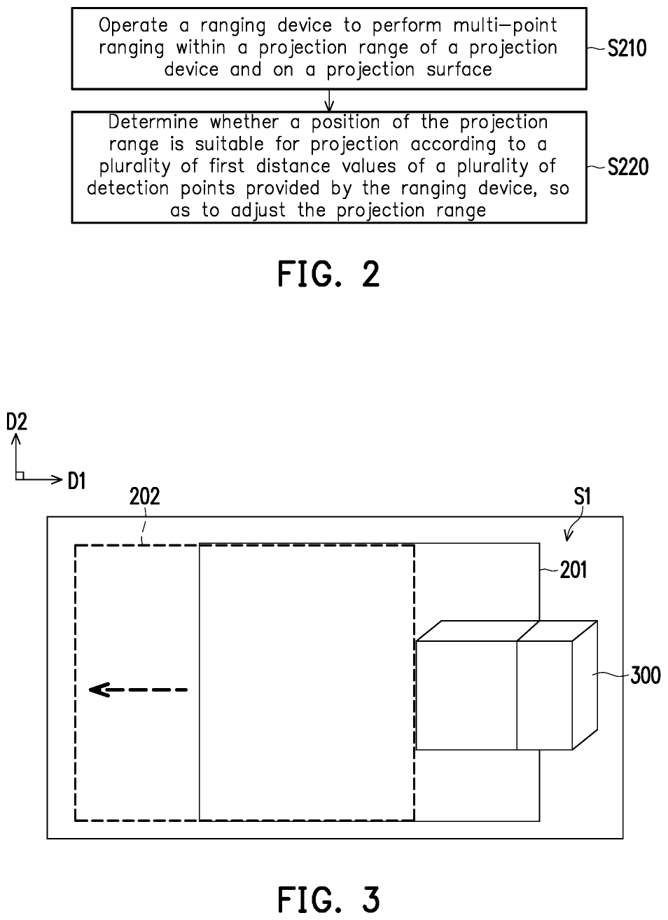

FIG. 1 is a schematic structural diagram of projection apparatus according to an embodiment of the invention. FIG. 2 is a flowchart of an automatic projection adjustment method according to an embodiment of the invention. Referring to FIG. 1, the projection apparatus 100 includes a control device 110, a storage device 120, a projection device 130 and a ranging device 140. The control device 110 is coupled (electrically connected) to the storage device 120, the projection device 130 and the ranging device 140. Referring to FIG. 1 and FIG. 2, the projection apparatus 100 may perform following steps S210 and S220 to automatically adjust a projection range. In step S210, the control device 110 may operate the ranging device 140 to perform multi-point ranging within the projection range of the projection device 130 and on a projection surface S1. In step S220, the control device 110 determines whether a position of the projection range is suitable for projection according to a plurality of first distance values of a plurality of detection points provided by the ranging device 140, so as to adjust the projection range. Therefore, the projection apparatus and the automatic projection adjustment method of the embodiment may implement an automatic adjustment function of a projection image.

In the embodiment, the control device 110 may include a central processing unit (CPU) related to a projection control function and a data calculation function, or other programmable general-purpose or special-purpose microprocessors, a digital signal processor (DSP), an image processing unit (IPU), a graphics processing unit (GPU), a programmable controller, an application specific integrated circuit (ASIC), a programmable logic device (PLD), other similar control devices or a combination of the above devices. In the embodiment, the storage device 120 may be a memory, such as a removable random access memory (RAM), a read-only memory (ROM), a flash memory, or similar components or a combination of the above components, which may be used to store related projection image data, projection control programs, and ranging calculation programs, etc., for the control device 110 to access and execute.

In the embodiment, the projection device 130 includes a projection light source 131, a projection optical engine 132 and an optical system 133. The projection light source 131 may include a light-emitting unit such as a discharge bulb, a light-emitting diode (LED), or a laser light source. The projection optical engine 132 may include a reflective spatial light modulator or a transmissive spatial light modulator. The reflective spatial light modulator may, for example, include reflective liquid crystal on silicon (LCOS) or digital micro-mirror device (DMD). The transmissive spatial light modulator may, for example, include a transparent liquid crystal panel. The optical system 133 may include a plurality of lenses, and the plurality of lenses may be arranged on an optical path of a projection light beam. In the embodiment, the control device 110 may control the projection light source 131 and the projection optical engine 132 to project the projection image on the projection surface S1 through the optical system 133, and may control a position and a range of the projection image.

In the embodiment, the ranging device 140 includes a detecting light source 141 and a time-of-flight (ToF) ranging detector 142. The detecting light source 141 may be a laser light source. The control device 110 may control the detecting light source 141 to emit a plurality of detecting light beams to a position of the projection surface S1 corresponding to the projection image in a simultaneous or non-simultaneous manner to form a plurality of detection points. For example, the control device 110 may control the detecting light source 141 to simultaneously emit a plurality of detecting light beams on the projection surface S1 to form a plurality of detection points. In addition, the control device 110 may control the detecting light source 141 to emit a plurality of detecting light beams on the projection surface S1 in a sequential scanning (non-simultaneous) manner to form a plurality of detection points. The control device 110 may control the ToF ranging detector 142 to receive a plurality of reflected light beams corresponding to the plurality of detecting light beams in a simultaneous or non-simultaneous manner, and calculate a plurality of distance values of the plurality of detection points to realize a multi-point ranging function. The ToF ranging detector 142 may perform direct time-of-flight (D-ToF) ranging detection or indirect time-of-flight (I-ToF) ranging detection, which is not limited by the invention.

FIG. 3 is a schematic diagram of shifting a projection range according to an embodiment of the invention. FIG. 4 is a schematic diagram of multi-point ranging according to an embodiment of the invention. Referring to FIG. 1 and FIG. 3, for example, the projection surface S1 is, for example, a wall or a projection screen. There is an obstacle 300 between the projection surface S1 and the projection apparatus 100. In other embodiments, the obstacle 300 is, for example, a convex object or a concave area on the projection surface S1. The projection surface S1 is, for example, parallel to a plane formed by respectively extending a direction D1 and a direction D2. As shown in FIG. 3, the projection apparatus 100 projects a projection image toward the projection surface S1. An original projection range 201 of the projection apparatus 100 contains the obstacle 300. As a result, since the area of the projection surface S1 covered by the projection range 201 is not flat, the projection device 130 of the projection apparatus 100 cannot perform effective projection on the projection range 201. In this regard, if the projection device 130 shifts the projection range 201 to a position of a projection range 202 in a direction opposite to the direction D1, the projection device 130 may perform effective projection on the shifted projection range 202. In addition, shifting of the projection range 202 and a judgment method are explained in the following embodiment of FIG. 4.

Referring to FIG. 1 and FIG. 4, in the embodiment, the control device 110 may operate the detecting light source 141 to project a plurality of detecting light beams toward the projection range 201 on the projection surface S1 to form a plurality of detection points P_1-P_N, where N is a positive integer. Then, the control device 110 may operate the ToF ranging detector 142 to receive a plurality of reflected light beams corresponding to the detecting light beams to calculate a plurality of first distance values corresponding to the detection points P_1-P_N. In the embodiment, the control device 110 may determine whether the first distance values have a portion exceeding a preset ratio to be abnormal distance values, so as to adjust the projection range 201 projected by the projection device 130. In other words, the control device 110 may use the first distance values to automatically determine whether a total area of one or more obstacles in the projection range 201 exceeds the preset ratio to significantly affect the deformation of the projection image, and adjust the projection range 201. As shown in FIG. 4, if the control device 110 determines that the detection points Pa_1-Pa_M have abnormal distance values, the control device 110 may determine that the projection surface S1 corresponding to the detection points Pa_1-Pa_M is in an uneven state (convex or recess) or there are obstacles. The positions of the detection points Pa_1-Pa_M may, for example, correspond to the position of the obstacle 300 as shown in FIG. 3.

It should be noted that in the embodiment, the plurality of first distance values corresponding to the plurality of detection points P_1-P_N may include a first portion belonging to the normal distance values and a second portion belonging to the abnormal distance values, and the first distance values of the second portion are respectively higher than the first distance values of the first portion plus a first preset value, or respectively lower than the first distance values of the first portion minus a second preset value. In other words, the abnormal distance values described in the embodiment may be greater than or less than the normal distance values, and a difference between the abnormal distance values and the normal distance values exceeds the first preset value or the second preset value, where the first preset value and the second preset value are allowable threshold values. For example, the normal distance value may be a preset value of 3 meters, and the allowable distance values may be between 3.1 meters and 2.9 meters (i.e., the first preset value and the second preset value are 0.1 meters). The distance value greater than 3.1 meters or less than 2.9 meters is determined as an abnormal distance value by the control device 110. The invention does not limit the values of the distance value and the preset value.

Then, in the embodiment, the control device 110 may shift the projection range 201 toward a direction opposite to a projection center to an area center of the second portion with the abnormal distance values in the projection range 201, where the projection center is, for example, a geometric center of the detection points P_1-P_N of the projection range 201, and the area center of the second portion is, for example, a geometric center of the detection points Pa_1-Pa_M, but the invention is not limited thereto. As shown in FIG. 4, the projection device 130 may shift the projection range 201 to the position of the projection range 202 in a direction opposite to the direction D1. In the embodiment, the control device 110 may shift a range boundary of the projection range 201 to a position where the detection points are adjacent to a part of the detection points Pa_1-Pa_M corresponding to the abnormal distance values. Alternatively, as shown by a shifting result of the projection range 202 of FIG. 4, the control device 110 may form a preset interval between the range boundary of the shifted projection range 202 and the detection points Pa_1-Pa_M with the abnormal distance values to avoid the situation that the range boundary of the shifted projection range 202 is still aligned with the obstacle 300, so that the shifted projection range 202 has a flat projection image, and a viewer may view a flat projection image. In addition, the preset interval is defined as a distance of a plurality of pixels in a direction D1. The distance of the plurality of pixels may be determined according to actual projection apparatus settings, which is not limited by the invention.

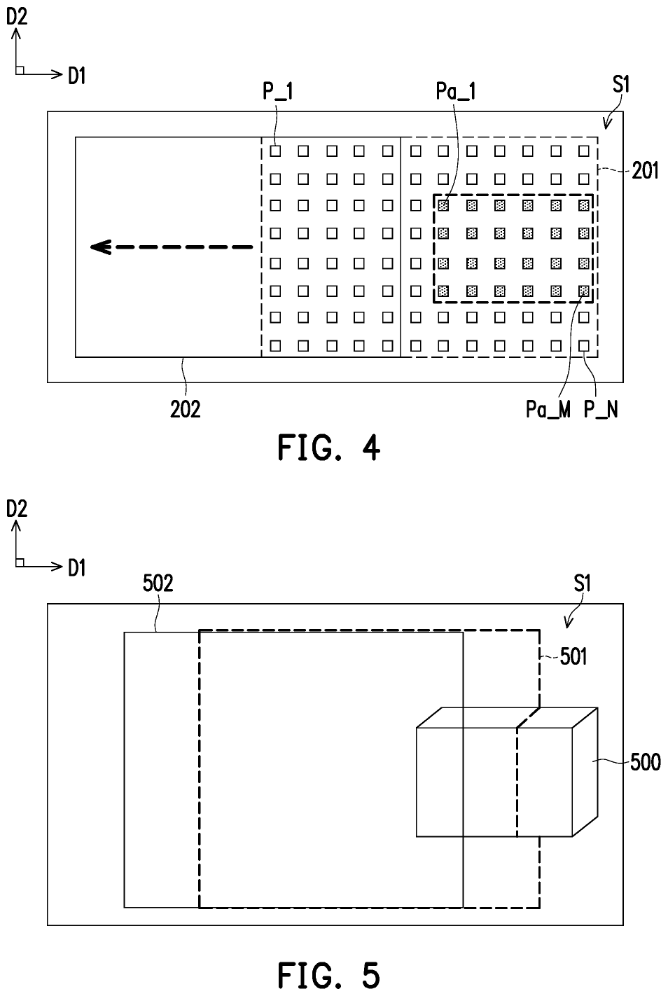

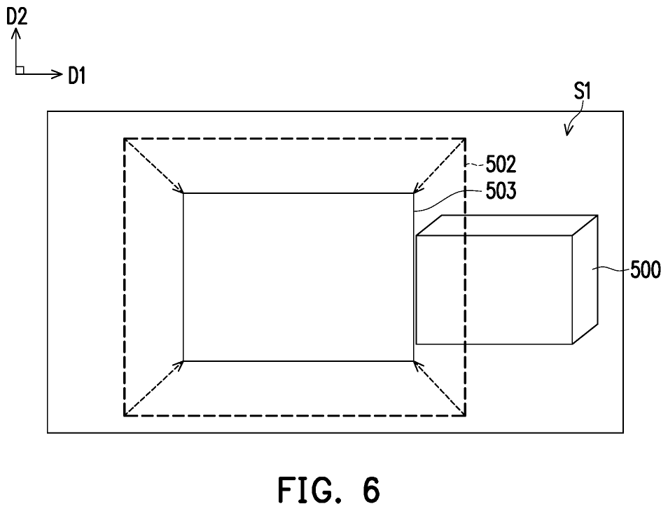

In addition, after the adjustment of the projection device 130 is completed, the control device 110 may operate the ranging device 140 to again perform multi-point ranging on the shifted projection range 202 to determine whether the position of the shifted projection range 202 is suitable for projection, so as to continue shifting the projection range 202. However, when the shifted projection range 202 has been an adjustment result of the maximum shift distance, and the control device 110 determines that a plurality of second distance values of the shifted projection range 202 have a portion exceeding a preset ratio to be the abnormal distance values, the control device 110 may zoom in the projection range 202, which is described in detail in the following embodiments of FIG. 5 and FIG. 6.

In addition, in some embodiments of the invention, if the portion of the projection range 201 having the distance values corresponding to the detection points being abnormal distance values is a plurality of regions, the control device 110 may shift the projection range 201 in a direction away from the plurality of regions. For example, there are a plurality of obstacles between the projection device 100 and the projection surface S1. Alternatively, in some other embodiments of the invention, the control device 110 may individually, sequentially and independently perform the projection range shifting operation as described in the above embodiment of FIG. 4 on the plurality of regions.

FIG. 5 is a schematic diagram of shifting a projection range according to another embodiment of the invention. FIG. 6 is a schematic diagram of zooming in a projection range according to an embodiment of the invention. Referring to FIG. 1 and FIG. 5, for another example, after the control device 110 operates the ranging device 140 to shift a projection range 501 to a projection range 502, if the shifted projection range 502 still contains an obstacle 500, and after the control device 110 performs the distance detection as described in the aforementioned embodiment, it is still determined that the position of the shifted projection range 502 is not suitable for projection, the control device 110 shifts the projection range 502 again.

Referring to FIG. 1 and FIG. 6, in the embodiment, when the shifted projection range 502 has been the adjustment result of the maximum shift distance, and the control device 110 determines that a plurality of second distance values of the shifted projection range 502 have a portion exceeding the preset ratio to be the abnormal distance values, the control device 110 may zoom in the shifted projection range 502. As shown in FIG. 6, the control device 110 may determine a range boundary of the zoomed-in projection range 503, so that there is a preset interval between the range boundary of the projection range 503 and the detection points corresponding to the abnormal distance values (representing the obstacle 500) to avoid the situation that the range boundary of the zoomed-in projection range 503 is still aligned with the obstacle 500, so that the zoomed-in projection range 503 has a flat projection image, and the viewer may view the flat projection image. In this regard, a method of zooming-in the projection range 502 may be deduced by analogy with reference of the shifting method of the projection range 202 according to the detection result of the detection point described in FIG. 4, and detailed description thereof is not repeated.

In addition, after the adjustment of the projection device 130 is completed, the control device 110 may operate the ranging device 140 to perform multi-point ranging on the zoomed-in projection range 503 to determine whether the position of the zoomed-in projection range 503 is suitable for projection, so as to continue adjusting the projection range 503. However, when the zoomed-in projection range 503 has been an adjustment result of the maximum zoom-in range, and the control device 110 determines that a plurality of third distance values of the zoomed-in projection range 503 have a portion exceeding the preset ratio to be the abnormal distance values, the control device 110 outputs a warning message. In other words, when the projection range is shifted and zoomed in, the control device 110 determines that the projection image projected by the projection device 130 cannot be effectively prevented from being projected on the obstacle after the shifting and zoom-in. The control device 110 may output the warning message, and the projection device 130 of the projection apparatus 100 projects the warning image to remind the user to move a placement position of the projection apparatus 100 or to remind the user to remove the obstacle.

Moreover, in some embodiments of the invention, if the portion of the projection range 201 having the distance values corresponding to the detection points being abnormal distance values is a plurality of regions, the control device 110 may perform the zoom-in operation of the projection range as described in the embodiment of FIG. 6 according to the detection points having the distance values being the abnormal distance value that are closest to a range center of the shifted projection range 502.

It should be noted that in some other embodiments of the invention, the control device 110 may also first perform the zoom-in operation of the projection range as described in the embodiment of FIG. 6, and then perform the shifting operation of the projection range as described in the embodiment of FIG. 4. Alternatively, the control device 110 may only perform the zoom-in operation of the projection range or the shifting operation of the projection range, which is not limited by the invention.

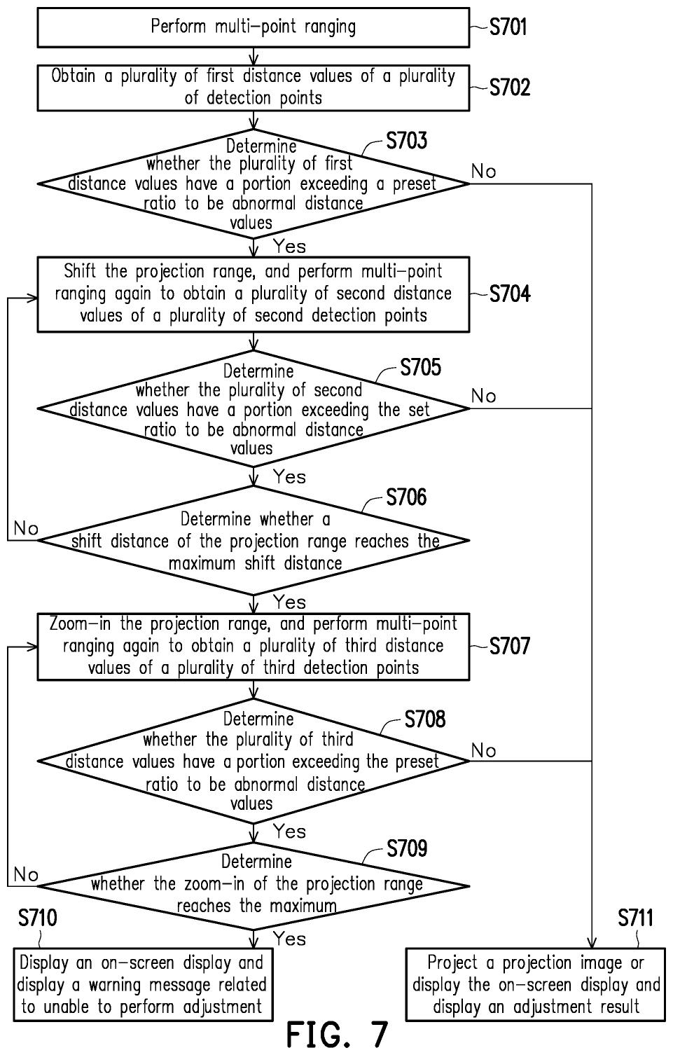

FIG. 7 is a flowchart of an automatic projection adjustment method according to another embodiment of the invention. Referring to FIG. 1 and FIG. 7, the projection apparatus 100 may perform following steps S701-S711 to perform automatic adjustment. In step S701, the control device 110 may operate the ranging device 140 to perform multi-point ranging. In step S702, the control device 110 may obtain a plurality of first distance values of a plurality of detection points through the ToF ranging detector 142. In step S703, the control device 110 may determine whether the plurality of first distance values have a portion exceeding a preset ratio to be abnormal distance values, where the preset ratio may be preset to be 1 to 2% of the normal distance value, and this value is not limited by the invention. It should be noted that the control device 110 may first determine the normal distance value, and the normal distance value may be a preset distance value set by the user, and in other embodiments, the normal distance value may be set by the control device 110. If not, the control device 110 executes step S711. In step S711, the control device 110 may operate the projection device 130 to project a projection image within the projection range on the projection surface S1, or the control device 110 may operate the projection device 130 to display an on-screen display (OSD) within the projection range on the projection surface S1, and display the current projection range. In this way, the user may confirm whether automatic adjustment is required or whether the unadjusted current projection range is appropriate by operating the OSD. The control device 110 may determine whether to subsequently project a projection image in the adjusted projection range according to the selected adjustment result of the OSD. If yes, the control device 110 executes step S704. In step S704, the control device 110 may operate the projection device 130 to shift the projection range, and perform multi-point ranging again to obtain a plurality of second distance values of a plurality of second detection points.

In step S705, the control device 110 may determine whether the plurality of second distance values have a portion exceeding a preset ratio to be abnormal distance values. If not, it means that the previous shifting operation of the projection range was successful, and the control device 110 executes step S711. If yes, it means that the current projection range is still not suitable for projection, so the control device 110 may execute step S706. In step S706, the control device 110 may determine whether a shift distance of the projection range reaches the maximum shift distance, and if not, step S704 and step S705 are executed again until shifting of the projection range reaches the maximum adjustable degree. If yes, it means that the shifting of the projection range has reached the maximum and the projection range may no longer be shifted. Then, in step S707, the control device 110 may zoom-in the projection range, and perform multi-point ranging again to obtain a plurality of third distance values of a plurality of third detection points. In step S708, the control device 110 may determine whether the plurality of third distance values have a portion exceeding a preset ratio to be abnormal distance values. If not, it means that the previous zoom-in operation of the projection range was successful, and the control device 110 executes step S711. If yes, it means that the current projection range is still not suitable for projection, and the control device 110 may execute step S709. In step S709, it is determined whether the zoom-in of the projection range reaches the maximum and the projection range cannot be zoomed in any more, if not, step S707 and step S708 are executed again until the range adjustment of the projection range reaches the maximum zoom-in degree. In step S710, the control device 110 may operate the projection device 130 to project within the projection range on the projection surface S1 to display the OSD and display a warning message related to unable to perform adjustment. Therefore, the automatic projection adjustment method of the embodiment may provide an effective automatic adjustment effect of the projection range.

However, regarding the related adjustment means and technical features of the projection range described in the embodiment, sufficient teaching, suggestion, and implementation description may be obtained by referring to the description of the above-mentioned embodiments of FIG. 1 to FIG. 6, and details thereof are not repeated.

In summary, the projection apparatus with automatic adjustment function and the automatic projection adjustment method of the invention may effectively sense whether the projection surface corresponding to the projection range is flat or not by means of multi-point flying ToF ranging. The projection apparatus with automatic adjustment function and the automatic projection adjustment method of the invention may automatically avoid obstacles or uneven areas on the projection surface by shifting the projection range and/or zooming-in the projection range, so that the projection device may perform effective projection operations in the adjusted projection range.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents. Moreover, any embodiment of or the claims of the invention is unnecessary to implement all advantages or features disclosed by the invention. In addition, the abstract and the name of the invention are only used to assist patent searching, and are not used to limit a claim range of the invention.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus with an automatic adjustment function, comprising a control device, a projection device and a ranging device, wherein
the projection device is coupled to the control device; and
the ranging device is coupled to the control device,
wherein the control device operates the ranging device to perform multi-point ranging within a projection range of the projection device and on a projection surface, and the control device determines whether a position of the projection range is suitable for projection according to a plurality of first distance values of a plurality of detection points provided by the ranging device, so as to adjust the projection range.

2. The projection apparatus as claimed in claim 1, wherein the ranging device comprises a detecting light source and a time-of-flight ranging detector, wherein
the detecting light source is coupled to the control device; and
the time-of-flight ranging detector is coupled to the projection apparatus,
wherein the control device operates the detecting light source to project a plurality of detecting light beams toward the projection range on the projection surface to form the plurality of detection points, and the control device operates the time-of-flight ranging detector to receive a plurality of reflected light beams corresponding to the plurality of detecting light beams to calculate the plurality of first distance values.

3. The projection apparatus according to the claim 1, wherein the control device determines whether the plurality of first distance values have a portion exceeding a preset ratio to be abnormal distance values, so as to adjust the projection range.

4. The projection apparatus according to the claim 3, wherein the plurality of first distance values comprise a first portion belonging to normal distance values and a second portion belonging to abnormal distance values, and the first distance values of the second portion are respectively higher than the first distance values of the first portion by a first preset value, or respectively lower than the first distance values of the first portion by a second preset value.

5. The projection apparatus according to the claim 3, wherein the control device shifts the projection range toward a direction opposite to a projection center of the projection range to an area center of the portion with the abnormal distance values in the projection range, and the control device operates the ranging device to perform multi-point ranging on the shifted projection range to determine whether a position of the shifted projection range is suitable for projection.

6. The projection apparatus according to the claim 5, wherein the control device shifts a range boundary of the projection range to a position where the plurality of detection points are adjacent to a part of the detection points corresponding to the abnormal distance values.

7. The projection apparatus according to the claim 5, wherein the control device forms a preset interval between a range boundary of the shifted projection range and the plurality of detection points having the abnormal distance values.

8. The projection apparatus according to the claim 5, wherein when the shifted projection range has been an adjustment result of the maximum shift distance, and the control device determines that a plurality of second distance values of the shifted projection range have a portion exceeding a preset ratio to be the abnormal distance values, the control device zooms in the shifted projection range, and the control device operates the ranging device to perform multi-point ranging in the zoomed-in projection range to determine whether a position of the zoomed-in projection range is suitable for projection.

9. The projection apparatus according to the claim 8, wherein when the shifted projection range has been an adjustment result of the maximum zoom-in range, and the control device determines that a plurality of third distance values of the zoomed-in projection range have a portion exceeding the preset ratio to be the abnormal distance values, the control device outputs a warning message.

10. The projection apparatus according to the claim 1, wherein the control device operates the projection device to display an on-screen display in the adjusted projection range, and determines whether to perform a subsequent projection in the adjusted projection range according to a selected adjustment result of the on-screen display.

11. An automatic projection adjustment method of a projection apparatus, comprising:
operating a ranging device to perform multi-point ranging within a projection range of a projection device and on a projection surface; and
determining whether a position of the projection range is suitable for projection according to a plurality of first distance values of a plurality of detection points provided by the ranging device, so as to adjust the projection range.

12. The automatic projection adjustment method according to the claim 11, wherein the step of performing the multi-point ranging comprises:
operating a detecting light source to project a plurality of detecting light beams toward the projection range on the projection surface to form the plurality of detection points; and
operating a time-of-flight ranging detector to receive a plurality of reflected light beams corresponding to the plurality of detecting light beams to calculate the plurality of first distance values.

13. The automatic projection adjustment method according to the claim 11, wherein the step of determining whether the position of the projection range is suitable for projection, so as to adjust the projection range comprises:
determining whether the plurality of first distance values have a portion exceeding a preset ratio to be abnormal distance values, so as to adjust the projection range.

14. The automatic projection adjustment method according to the claim 13, wherein the plurality of first distance values comprise a first portion belonging to normal distance values and a second portion belonging to abnormal distance values, and the first distance values of the second portion are respectively higher than the first distance values of the first portion by a first preset value, or respectively lower than the first distance values of the first portion by a second preset value.

15. The automatic projection adjustment method according to the claim 13, wherein the step of adjusting the projection range comprises:
shifting the projection range toward a direction opposite to a projection center of the projection range to an area center of the portion with the abnormal distance values in the projection range; and
operating the ranging device to perform multi-point ranging on the shifted projection range to determine whether a position of the shifted projection range is suitable for projection.

16. The automatic projection adjustment method according to the claim 15, wherein the step of shifting the projection range comprises:
shifting a range boundary of the projection range to a position where the plurality of detection points are adjacent to a part of the detection points corresponding to the abnormal distance values.

17. The automatic projection adjustment method according to the claim 15, wherein the step of shifting the projection range comprises:
forming a preset interval between a range boundary of the shifted projection range and the plurality of detection points having the abnormal distance values.

18. The automatic projection adjustment method according to the claim 15, further comprising:
zooming in the shifted projection range when the shifted projection range has been an adjustment result of the maximum shift distance, and it is determined that a plurality of second distance values of the shifted projection range have a portion exceeding a preset ratio to be the abnormal distance values; and
operating the ranging device to perform multi-point ranging in the zoomed-in projection range to determine whether a position of the zoomed-in projection range is suitable for projection.

19. The automatic projection adjustment method according to the claim 18, further comprising:
outputting a warning message when the zoomed-in projection range has been an adjustment result of the maximum zoom-in range, and it is determined that a plurality of third distance values of the zoomed-in projection range have a portion exceeding the preset ratio to be the abnormal distance values.

20. The automatic projection adjustment method according to the claim 11, further comprising;
operating the projection device to display an on-screen display in the adjusted projection range, and determining whether to perform a subsequent projection in the adjusted projection range according to a selected adjustment result of the on-screen display.
